(19) United States
(12) Patent Application Publication
(10) Pub. No.: US 2011/0208611 A1
(43) Pub. Date: Aug. 25, 2011

(54) PARTICIPANT TRACKING SYSTEM AND METHOD OF USE

(76) Inventors: Vincent Leroy Campbell, Parkville, MO (US); Steven Michael McGarrah, Lakewood, CO (US)

(21) Appl. No.: 13/022,612

(22) Filed: Feb. 7, 2011

Related U.S. Application Data
(60) Provisional application No. 61/301,713, filed on Feb. 5, 2010.

(51) Int. Cl. G06Q 30/00

(52) U.S. Cl. 705/26.25

(57) ABSTRACT

The participant tracking system of the present invention includes a plurality of participant information records stored in a database, a remote user interface connected to a centralized processor and digital data storage device through a network wherein the database is stored on the digital data storage device. The participant tracking system of the present invention may further include a security feature that prevents unauthorized access to the database and the participant information records. The participant information record includes the participant's personal information, a digitized sample of one of the participant's unique biometric characteristics, and an updatable participation history. The participant tracking system of the present invention uses a biometric characteristic to verify the identity of a participant and ensures that the participant is not exceeding the regulated quantity of goods or frequency or duration of services within a defined time period.

### CROSS-REFERENCE TO RELATED APPLICATIONS

The present application claims the benefit of U.S. Provisional Patent Application No. 61/301,773 to Campbell which is hereby incorporated by reference.

### BACKGROUND OF THE INVENTION

There are many activities, over-the-counter products, or other actions that a person may engage in or purchase throughout their life that are regulated by the United States federal government or a state agency. Often the regulation focuses on protecting the individual participant from over-indulging, over-consuming, or over-participating in an otherwise legal action or activity that may become dangerous to the participant if the action or activity is engaged in too frequently. For example, the government currently regulates the frequency in which a person may donate their blood plasma to two times in seven days and only one time in a two day period. Other concerns involve the government determining the public good is served by regulating limits on the amount and frequency that an otherwise legal product may be purchased. For example, many states regulate the sale of over-the-counter medicines, such as ephedrine, pseudoephedrine, and phenylpropanolamine that are sometimes used as an ingredient in the manufacture of illegal drugs.

The plasma donation industry has had a difficult time tracking the donation participants to properly comply with the government regulations. Donor participants are paid for their donation and, therefore, in an attempt to earn more money, the participant donors often attempt to donate more often than legally allowed by going from one competitor to another. Currently, the most pervasive way for a plasma donation center to verify whether a potential donor is not donating more frequently than allowed is to phone or fax donor information between competitors. In more populated areas, there may be numerous competitors that a center must consult. This takes considerable staff resources and is less than fool-proof. If the plasma donation center staff cannot verify the donation history, then often times a hold will be placed on that donor and they will have to return later that day, or another day in order to donate. This results in tremendous inefficiencies.

To circumvent the system, a potential donor may use another person's identity thereby allowing that donor to donate at different clinics. Even if the plasma donation center verified the “false” identity with its competitors, there would be no donation conflict because the potential plasma donor uses a different (presumably at least one false) identity at each of the centers.

The FDA, which polices the plasma donation industry, recently found up to fifty-five violations of the donation frequency regulations in a thirty-day period at one plasma donation center alone. If plasma donation centers are levied a fine for each violation of these regulations, it will take a considerable sum of money to pay-off the fines for such numerous violations. Further, continual violations of the regulations may result in a plasma donation center losing its license or certification to harvest plasma. Thus, the bad actions of plasma donors trying to scam the system results in harm to the plasma donation centers. To date there is no sure way for a plasma donation center to protect itself and ensure it complies with the regulations. In other words, there is no industry-wide, centralized system providing plasma donation centers a way to validate the identity of a participant donor, and to track and continually update the participant donor's donation history using a centralized database that is accessible twenty-four hours a day and three-hundred sixty-five days a year by all centers. Therefore, it would be beneficial to have an industry-wide system to track donors that all plasma donation centers may access.

Similarly, there is no current system known in the art that provides retail pharmacies or drug stores a way to verify the purchase history of a person buying otherwise legal over-the-counter drugs that are regulated as to the amount and frequency of purchase across the entire industry. Thus, a person using these otherwise legal over-the-counter pharmaceuticals as a base or ingredient in the manufacture of illegal drugs may go from one retail drug store or pharmacy to another in an attempt to purchase the necessary quantity of these regulated over-the-counter pharmaceuticals to manufacture illegal drugs without being tracked.

Therefore, a need exists for a participant tracking system that includes a centralized searchable database tracking all participants in an industry to assist the centers and retail outlets that offer regulated goods or services in a regulated industry that uses a biometric identifier to validate the identity of a participant to avoid providing goods or services in violation of industry regulations and, thereby, avoid monetary fines or other punitive consequences for providing goods or services outside of the regulations. There is a further need for a participant tracking system in the plasma donation industry wherein all plasma donation centers throughout the country can verify the identity and participation history of a potential plasma donation participant on a single centralized database that includes a participant donor's biometric identifier and the participant donor's donation history to prevent a donation center from providing plasma donation services to a participant in violation of the industry regulations.

### SUMMARY OF THE INVENTION

The present invention is generally directed to a participant tracking system and method of use for tracking a participant's activity when industry regulations restrict the amount, frequency or duration of an otherwise legal activity.

The participant tracking system of the present invention includes a plurality of participant information records stored in a database, a remote user interface connected to a centralized processor and digital data storage device through a network where the database is stored on the digital data storage device. The participant tracking system of the present invention may further include a security feature that prevents unauthorized access to the database and the participant information record. The participant information record includes at least one item of the participant's personal information, a digitized reading of at least one of the participant's unique biometric characteristic, and an updatable participation history for each participant. The participation history includes all of the participant's activities in obtaining and attempting to obtain the regulated goods or services.

The participant tracking system of the present invention helps a user at a retail outlet or a center offering regulated goods or services to verify the identity of the participant, view the participant's participation history, and compare the participation history to the regulations to ensure that the participant is not exceeding the regulated quantity of goods or frequency of services within a defined time period. When a participant seeks to obtain the regulated goods and services, the user can search the database for the participant's information record at the remote user interface. The security feature ensures that the user and/or the remote user interface are validated in order to access the personal information records stored on the database. The participant tracking system of the present invention can be configured to search the database using any item of information unique to the participant including their name, social security number, driver license number or even a digitized reading of the participant's unique biometric identifier.

Once the participation record is retrieved on the remote user interface, the participant tracking system of the present invention will allow for the verification of the participant's identity. The participant tracking system will take a reading of at least one of the participant's unique biometric characteristics and compare the obtained reading with the digitized version of the same biometric characteristic(s) stored in the participant information record. If the read biometric characteristic does not match the biometric characteristic stored in the file, then the participant has failed to pass the verification and the person attempting to obtain the goods or services is not the same as the originating participant. Accordingly, the participant will be denied the goods and services and further inquiry may be pursued.

If the read biometric characteristic matches the biometric characteristic stored in the participant's information record, then the participant's identity has been verified. The participant's participation history is retrieved after the participant's identity has been verified. The participant's participation history is compared to the regulated requirements. If the participant's participation history does not meet the regulatory requirements, the participant's status for this inquiry is tagged a “failure” and the participant is denied the goods or services. The participation history is updated to include the date and time of this failed attempt. If the participation history satisfies all of the regulated requirements, the participant's status for this inquiry is tagged a “success” and the participant is approved to receive the regulated goods or services. The participant's participation history is updated to reflect the date, quantity, amount, or duration of the received goods or services. The updated participant information record is saved in an updated database and will be available the next time the participant seeks to obtain the regulated goods and services.

The participant tracking system of the present invention may be used in the plasma donation industry, the blood donation industry, the sale of regulated over-the-counter pharmaceuticals such as ephedrine, pseudoephedrine, and phenylpropanolamine, or any other application where the otherwise legal activities of a person are subjected to a regulated frequency, quantity, or duration in a given period of time, or any other regulated requirement.

Other aspects and advantages of the present invention will be apparent from the following detailed description of the preferred embodiments and the accompanying drawing figures.

### BRIEF DESCRIPTION OF THE DRAWING

The accompanying drawings form a part of the specification and are to be read in conjunction therewith, in which like reference numerals are employed to indicate like or similar parts in the various views, and wherein:

FIG. 1 is a schematic view of one embodiment of the participant tracking system in accordance with the teachings of one embodiment of the present invention;

FIG. 2 is a schematic view of another embodiment of the participant tracking system in accordance with the teachings of the present invention; and

FIG. 3 is a flow diagram illustrating the operation of one embodiment of the participant tracking system in accordance with the teachings of the present invention.

### DETAILED DESCRIPTION OF THE INVENTION

The following detailed description of the present invention references the accompanying drawing figures that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

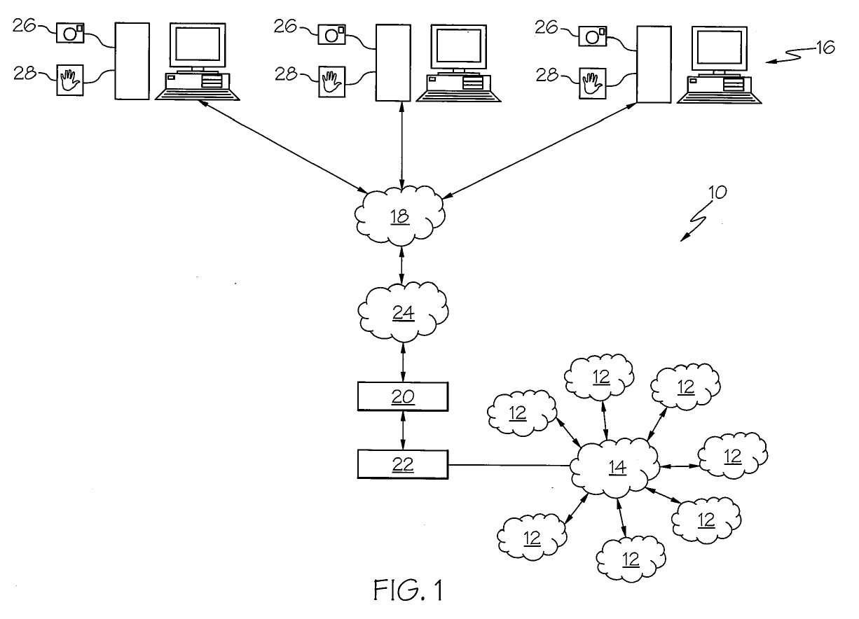

FIG. 1 is a schematic diagram of the participant tracking system 10 of the present invention. Participant tracking system 10 generally includes a database 14 containing a plurality of personal information records 12, a plurality of remote user interfaces 16 located in a plurality of entities providing the regulated goods or services, a network 18, at least one central processor 20, at least one digital data storage device 22, and at least one security feature 24. Participant tracking system 10 may be used in the plasma donation industry, the blood donation industry, the sale of regulated over-the-counter pharmaceuticals such as ephedrine, pseudoephedrine, and phenylpropanolamine, or any other application where the otherwise legal activities of a person are subjected to a regulated frequency, quantity, or duration in a given period of time.

Participant information record 12 is generally an electronic file or folder containing various items of personal information of each participant and at least one unique biometric identifier. A participant's personal information may include one or more of a participant's name, age, weight, social security number, address, phone number, e-mail address, place of employment, insurance carrier, emergency contact, driver's license number, work information, or any other item of information necessary to provide the goods or services. Biometric identifiers may include a fingerprint, palm print, face-recognition, DNA sequence, hand geometry, iris scan, retina scan, or combination thereof, or any other biometric identifier now known or developed in the future. An embodiment of participant tracking system 10 that includes using a scan of one or more fingerprints is preferable because fingerprint scanners may be economically purchased and there are already known software applications available that obtain, compare, identify and match the unique biometric parameters obtained from scanned fingerprint images within a known database of fingerprints.

Database 14 generally organizes and stores data associated with a plurality of participant information records 12 and will typically include only one participant information record per participant. Databases are applications that are well known in the art to organize and store large amounts of information in a way that makes the data easy to retrieve. Database 14 is generally controlled using a database management system comprising software that operates the database and provides storage, access, security, backup and other functions. Database 14 may be operated by any known database management system known in the art or hereafter developed including MYSQL™, PostgreSQL, MICROSOFT® Access, SQL SERVER®, FILEMAKER®, ORACLE®, SYBASE®, DBASE™, Clipper, and VISUAL FOXPRO®. One embodiment of the present invention includes database 14 being generally stored and supported upon data storage device 22. Another embodiment of the present invention includes database 14 being managed by MYSQL that is hosted on a server that implements a LINUX® or MICROSOFT® operating system. Yet another embodiment of the present invention includes database 14 being configured to store participant information records 12 for all participants in a given industry throughout the United States.

Remote user interface 16 is generally a PC or MAC® personal computer including a monitor and keyboard that is remotely located at a retail outlet or center that offers the regulated goods or services. Remote user interface 16 generally comprises a central processing unit in electronic communication with a local hard drive or other digital storage medium. Remote user interface 16 may be a desktop or laptop computer having the minimum performance characteristics required to support access through network 18. In one embodiment, remote user interface 16 includes a desktop PC computer with an internet connection wherein the user is an employee of the center. Remote user interface 16 also includes a digital camera 26 and a biometric characteristic reader 28. Digital camera 26 may be a still or video camera. Digital camera 26 may be integrated into the monitor or may be free standing. One embodiment includes biometric characteristic reader 28 being a fingerprint scanner. In an alternative embodiment, biometric characteristic reader 28 is a retina scanner. Biometric characteristic reader 28 may be any device that measures a unique biometric identifier described above now known or hereafter developed.

Network 18 generally electronically connects remote user interface 16 with processor 20 and digital storage device 22 where database 14 of the present invention is stored on digital storage device 22. Network 18 may be any private or public network now known or hereafter developed. The World Wide Web or internet is a preferable public network because it can be readily accessed by the users of participant tracking system 10 and includes no further infrastructure or installation costs. An alternative embodiment implements a private user network linking each individual retail outlet or center to the central processor 20 and digital data storage device 22. Network 18 may be a wired or wireless network, or combination thereof.

Central processor 20 is generally a central processing unit that is in electronic communication with digital data storage device 22. Digital data storage device 22 may be any digital storage device now known or hereafter developed including, but not limited to, an internal or external hard drive, random-access memory (“RAM”), optical disk drive, a flash drive, magnetic tape, memory card, floppy disks, standalone RAM disks, and an internal zip drive. Central processor 20 may be housed together with digital storage device 22 in a server or other central computer accessed through network 18. The server may be virtualized or otherwise modified to improve or control the server's performance. The participant tracking system of the present invention may also include a back-up server (not shown) that is identical to the operating database server and may be synced at predetermined time intervals to ensure that the back-up server contains identical software and records to the active system components.

As shown in FIG. 1, participant tracking system 10 also includes at least one security feature 24 to prevent unauthorized users from obtaining access to the participation information records 12 in database 14 stored in data storage device 22. Security feature 24 may be any security feature now known or hereafter developed that selectively grants access to software applications and/or databases including username and password, software key, a USB key inherent in each biometric reader, a serial number implanted into the firmware of a biometric reader, biometric identification, and recognition of an Internet Protocol (IP) address. The participant tracking system of the present invention may also include security features mandated by law to protect a person's electronic medical data under Health Insurance Portability and Accountability Act (“HIPAA”), HITECH Act, and Electronic Patient Health Information (“EPHI”). This high level of security will generally be included in the participant tracking system of the present invention when the participant information record includes any of the participant's medical history and/or records.

One embodiment of security feature 24 includes using more than one security feature in series to provide extra security for participant tracking system 10. For example, a piggy-backed security feature 24 including a firewall that only allows a user to access database 14 using HTTPS destination service. One embodiment of security feature 24 implements a username/password combination combined with the validation of a USB key contained in the biometric characteristic reader used at a registered retail outlet center in order to gain access to search for and retrieve data stored in database 14. Participant tracking system 10 may also relate the USB key to a particular center or retail outlet and its physical address or geographical location thereby identifying the center or retail outlet with other information added to the participation history in participant information record 12. The participant tracking system of the present invention may also track the activity of each center or retail outlet to provide a summary of the center's or retail outlet's activity for a week, month, year, or other desired time interval. Visitors who have not been authorized to access the participant tracking system of the present invention by security feature 24 will be re-directed to a public accessible website and limited to viewing public pages and information. The public website may provide information to become a user and sign-up or contract for access to the participant tracking system of the present invention.

In addition to using security feature 24 to inhibit access to the participant tracking system of the present invention, participant tracking system 10 may be configured with a cryptography protocol such as Transport Layer Security (TLS) or Secure Sockets Layer (SSL) to provide communication security by encrypting data as it travels from data storage device 22 to remote user interface 16. There are many combinations of remote user interfaces, processors, digital data storage devices, and servers that may be configured to comprise the participant tracking system of the present invention and the embodiment shown in FIG. 1 is merely an example of one such configuration.

In use, the participant tracking system of the present invention illustrated in FIG. 1 tracks and validates a participant seeking to receive certain goods or services wherein the amount, frequency, or duration are regulated. A user of participant tracking system 10 logs onto remote user interface 16 located in the retail outlet or center at which a participant comes to obtain the regulated goods or services. The user of participant tracking system 10 can be a clinician or employee of a retail outlet or center providing the regulated goods and services. The user accesses the centralized processor 20 and database 14 from remote user interface 16 through network 18. In one embodiment, the user accesses a website providing access to database 14 and the central processor 20 and digital data device 22 through the internet 18. Participant tracking system 10 includes security feature 24 that the user must satisfy to obtain access to database 14 and the plurality of participant information records 12.

Once central processor 20 and data storage device 22 are accessed, the user can search database 14 for a particular participant using a piece of personal information such as a name, social security number, passport number, or driver's license number or one of the participant's unique biometric characteristics obtained through the biometric characteristic reader 28. In one embodiment, the participant is directed through this process by an interactive website that is part of participant tracking system 10. Processor 20 searches database 14 stored on data storage device 22 using database management software. If the participant has obtained the same regulated goods or services at any center or retail outlet connected to participant tracking system 10, there will be a participant information record 12 stored in database 14 for that participant. Participant information record 12 may be retrieved from database 14 through a search performed using one or more items of personal information. Participant tracking system 10 then obtains a reading of the participant's biometric characteristic and verifies that the biometric identifying characteristic read matches the participant's stored biometric identifying characteristic in personal information record 12.

Since each participant information record 12 contains a digital representation of at least one of a participant's biometric identifying characteristics, one embodiment of participant tracking system 10 includes reading the participant's biometric identifying characteristic, digitizing it and having processor 20 search database 14 for a matching digitized biometric characteristics stored in the personal information records 12 of participant tracking system 10. Participant tracking system 10 retrieves the participant information record 12 that contains the match to the biometric characteristic read at remote user interface 16. Searching database 12 using the digitized biometric identifying characteristic read at the center or clinic when the participant seeks to obtain the regulated goods and services allows a user to retrieve the exact personal information record 12 for the person physically present and prevents a participant from using an alias or false identity to obtain more goods or services than allowed by the regulations. In this embodiment, if the read biometric characteristic does not match any participants in database 14, then the digitized biometric identifier is stored into a new participant information record with the participant's personal information gathered at remote user interface 16 by an interactive prompt of participant tracking system 10 or manually by the user.

If the personal information search does not return any participant information records 12 or a participant represents that he/she has never obtained the regulated goods or services at any retail outlet or center, participant tracking system 10 creates a new participant information record 12. The participant's personal information is gathered either through an interactive display at remote user interface 16 or manually entered by a user at remote user interface 16. Participant tracking system 10 may prompt a user or the participant to take a picture of the participant's face using digital camera 26 and the digital picture is stored in participant information record 12 of the participant. Participant tracking system 10, or the user, prompts the participant to have his/her unique biometric characteristic read using biometric characteristic reader 28 and the digitized biometric characteristic is stored in participant information record 12. One embodiment of the present invention includes participant tracking system 10 being configured to compare the read biometric characteristic to each biometric characteristic identifier contained in each personal identification record 12 stored in database 14 to verify the participant is not already in the system under a different identity to prevent a participant from obtaining services under more than one identity. If the read biometric identifying characteristic matches the biometric identifying characteristic in another participant information record 12, the participant is questioned about the discrepancy and may be disqualified from obtaining the regulated goods and services.

Once participant tracking system 10 retrieves the participant's participation history from database 14 a determination can be made as to whether or not participant can obtain the regulated goods or services. One embodiment includes processor 20 comparing the participant's participation history to the current regulations or industry standards that govern the particular industry. An alternative embodiment relies on the user to determine if the participant's participation history conflicts with any current regulations or industry standards. If the participant's participation history satisfies all of the current industry regulations or industry standards, the participant status is tagged a “success.” If the participant's participation history conflicts with any of the industry regulations or industry standards, the participant status is tagged a “failure.” Either status is recorded as part of participant information record 12 with the current date and time of day to update the participant's participation history. An embodiment of participant tracking system 10 may include one or more of the following additional participant status tags: “cancelled” when a scheduled donation has been cancelled; “hold” when a temporary or permanent hold is placed on the participant for some reason provided in participant information record 12 and the participant will automatically receive a status of “failure” if the participant attempts to receive the goods or services while a hold is in effect; and “removed” is used to indicate that a hold was removed and participant information record 12 should include who removed the hold and why.

If a participant's verification was a success, the participant may obtain the requested goods and services. The user will update the performance of the services or the amount and/or receipt of the goods into the participant's participation history at remote user interface 16. The updated participant information record 12 is then imported into database 14 through network 18 (the internet) and the updated participant information record 12, including the status tag for this inquiry, is stored on data storage device 22 for future use.

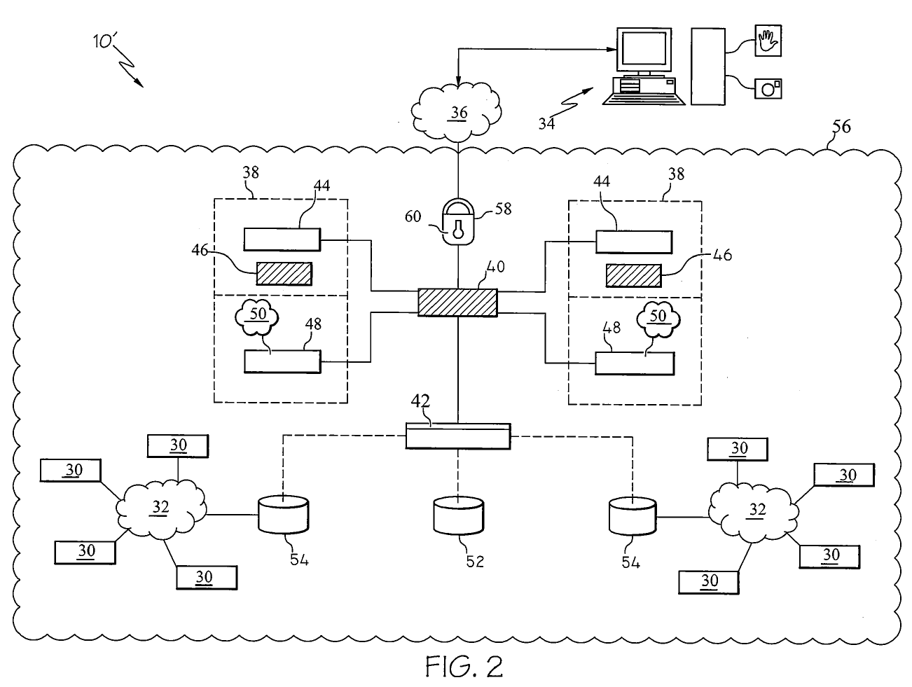

Another embodiment of participant tracking system 10′ of the present invention is shown in FIG. 2 and is contained in a private cloud computer architecture including three processors with integrated digital data storage devices in three physical servers. Participant tracking system 10′ includes a database 32 containing a plurality of participant information records 30, at least one remote user interface 34 located in each of a plurality of entities providing the regulated goods or services, a network 36, at least one front-end server 38, a physical switch 40, at least one back-end server 42, and a security feature 58. One embodiment of security feature 58 further includes firewall 60 as shown.

Database 32 is substantially identical to database 14 as described above. Participant information record 30 is substantially identical to participant information record 12 as described above. Remote user interface 34 is substantially identical to remote user interface 16 described above. The processors and digital data storage devices included in the servers 38 and 42 of participant tracking system 10′ are substantially identical to processor 20 and digital data storage device 22 used in participant tracking system 10 as describe above. Security feature 58 is substantially similar to security feature 24 as described above.

In participant tracking system 10′, one or more servers 38 or 42 may be virtualized so that participant tracking system 10′ includes up to five or six virtual servers (not shown). One embodiment includes two front-end servers 38 being virtualized to include at least one virtual machine 44, at least one virtual switch 46, and at least virtualized data storage device 48. At lease one virtualized data storage device 48 may have an access database 50 stored thereon. The five or six virtual servers integrated into servers 38 and/or 42 comprise a virtual environment 56 of participant tracking system 10′. In one embodiment, virtual environment 56 of participant tracking system 10′ also includes security feature 58. Utilizing a plurality of physical servers and virtualized servers provides a fully redundant, fault-tolerant, and automatically load-balanced system for both the front-end servers 38 and services—HTTP, HTTPS, FTP, etc.—and the back-end database servers 42 and database services. This configuration is also easily expanded if load requirements dictate expansion. There are many combinations of processors, digital data storage, servers, and virtual servers that may be configured to comprise participant tracking system 10′ and the embodiment shown in FIG. 2 is merely an example of one such configuration.

In one embodiment of the present invention illustrated in FIG. 2, at least one front-end server 38 hosts and runs a website that provides the portal to database 32 and participant information records 30 stored therein. One embodiment includes front-end server 38 having a processor that provides a processing speed ranging from about 1.86 to 2.53 gigahertz on 8×64 bit cores and providing RAM in a range between about 32 to 128 gigabytes. Participant tracking system 10′ includes a back-end server 42 that is a virtualized partitioned database server in network communication with at least one front-end server 38. Back-end server 42 may include a processing speed in a range of about 1.86 to 3.20 gigahertz, RAM in a range between about 32 to 128 gigabytes, and up to about 6.0 terabytes of hard drive disk storage. However, a person of skill in the art will recognize that processing speeds, RAM memory, and hard-drive memory capacity are in a continual state of technological advancement and the range of speeds and memory capacity for the servers as described herein are merely illustrative. Thus, any processing speed, RAM or hard drive storage capacity now known or hereafter developed is within the scope of the present invention.

Participant tracking system 10′ as shown in FIG. 2 further includes back-end server 42 having one internet services partition 52 and two participant information database partitions 54. Internet services partition 52 is a default partition that generally hosts the secure website pages which generally provide the templates for the interactive use of database 32 and other information and/or instructions to a user. The front-end servers 38 actually run the website and pull information from the back-end server 42 providing full access and operation of database 32 of participant tracking system 10′ of the present invention. For validated users of participant tracking system 10′, the user can retrieve information from the back-end server 42 through its processor that provides and facilitates access to create, search, find, recall, compare, and update participant information records 30 at remote user interface 34. At least one copy of all participant information records 30 will be stored on back-end server 42. One embodiment includes a back-up server (not shown) containing updated copies of database 32 and participant information records 30 that are substantially identical contents as back-end server 42 at any given time.

One embodiment includes the individual USB code of each particular biometric characteristic reader being contained in access database 50 stored on a digital data storage device 48 in electronic communication with security feature 58. Security feature 58 reads the USB key from the USB device plugged into or connected to the particular remote user interface 34 attempting to access database 32 of participant tracking system and security feature compares that USB code to the known USB codes in access database 50 that are approved to access participant tracking system 10′. If the USB code is in access database 50, security feature 58 grants access to database 32 stored on digital storage device 54.

In one embodiment of the present invention shown in FIG. 2, all public connections to database 32 will be done via SSL. Once a user has gained access through security feature 58, the virtual machines 44 run the web-based software and the virtual switches 46 operate through a single physical switch 40 routing virtually simultaneous searching and verification of data in order to recall the physical data replication links between back-end server 42 and front-end servers 38. The front-end servers 38 may be virtualized and are in electronic communication with back-end server 42. Back-end server 42 may also be virtualized. A physical switch 40 directs the flow of information between the front-end servers 38 and back-end server 42 and ultimately out to remote user interface 34 as shown in FIG. 2. The virtual switch within the virtual environment 56 allows the virtualized front-end servers 38 to connect with the back-end server 42 and database 32 only over a specific port provided by physical switch 40. This configuration in combination with the username/password and USB key validation provides an extremely secure site because in order for a hacker to successfully attack the system and access the data in database 32, they would have to crack the password requirement, USB code validation, SSL, firewall, physical switching and virtual switching.

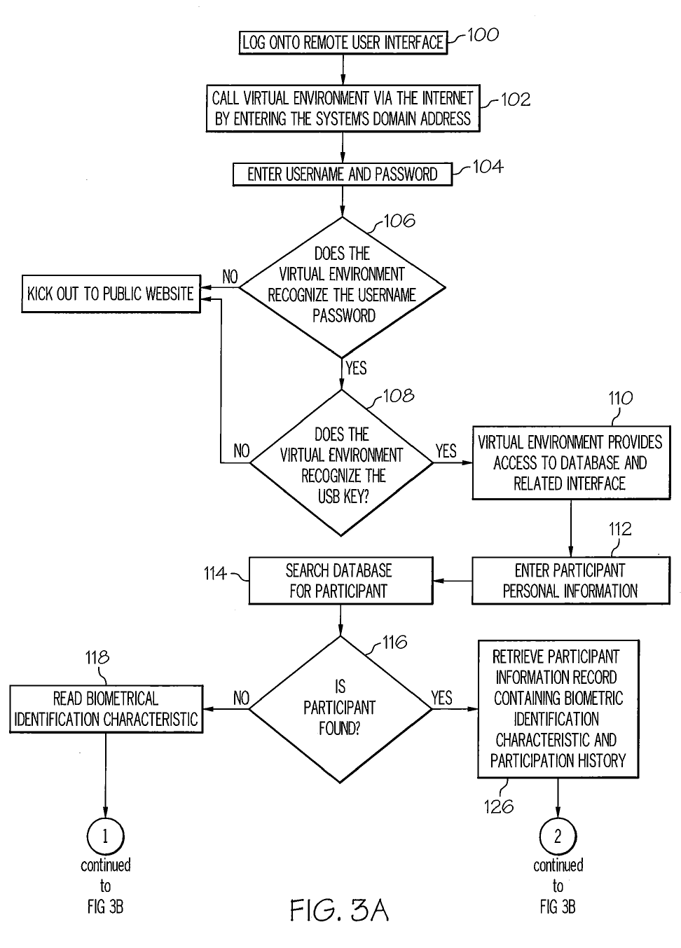

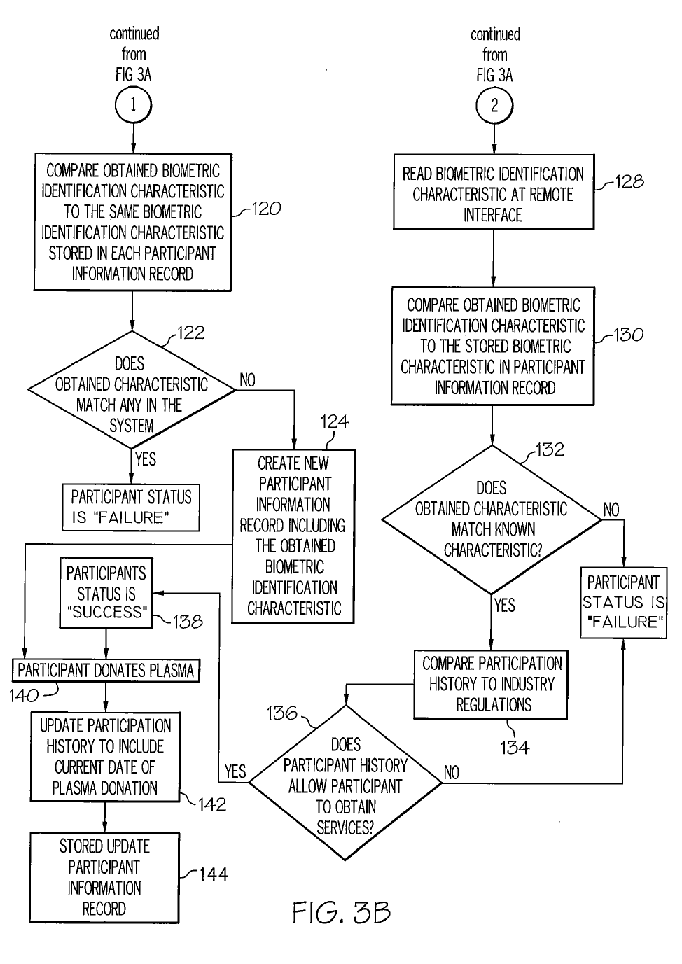

FIG. 3 is a flow-chart describing the method for using participant tracking system 10′ of FIG. 2 as it is applied to the plasma donation industry. In step 100, a user logs onto remote user interface 34 and, in step 102, calls upon the virtual environment 56 (virtualized servers and firewall) of participant tracking system 10′ through the internet 36 by accessing a website at a known domain name address. A user of the system of the present invention will generally be a clinician or employee of the centers or retail outlets offering the regulated goods or services. The user is prevented from accessing database 32 by security feature 58 in the virtual environment 56. Security feature 58 is configured to request the user to enter a username and password. In step 104, the user enters a username and password. As shown in FIG. 2, security feature 58 is in electronic communication with at least one front-end server 38 that includes access database 50 and, in step 106, security feature 58 queries access database 50 to validate the user's username and password. As shown in FIG. 3, if the user cannot provide a valid username and password, they are kicked out to a public website that is detached from the data and database 32 of participant tracking system 10′.

If security feature 58 validates the username and password, then in step 108, security feature 58 communicates with remote user interface 34 to obtain the USB key from the biometric characteristic reader and security feature 58 again queries access database 50 to validate the USB code. If security feature 58 does not recognize the USB key, it would then kick the user to a public website that is detached from the data and database 32 of the present invention. If security feature 58 recognizes the USB key and verifies that the biometric characteristic reader of remote user interface 34 is that of a registered user, then as shown in step 110, security feature 58 provides access to remaining components of virtual environment 56 including database 32 and the web-based interface that provides searching, editing, updating, and other interactions with database 32.

Once a user has access to database 32, in step 112, the user enters one or more items of the participant's personal information, preferably at least the participant's name or social security number. In step 114, the database management software will search database 32 for the participant's personally identifiable information. Next, in step 116, participant tracking system 10′ determines if a participant information record 30 that includes the searched item of participant's personal information is contained in database 32. As shown in step 118, if the prospective participant does not have a participant information record 30 in participant tracking system 10′, the fingerprint of one or more of the participant's fingers is scanned using a biometric characteristic scanner and the unique biometric parameters of the fingerprint are identified. In step 120, the virtualized environment 56 compares the unique biometric parameters of the fingerprint to the unique biometric parameters of each fingerprint stored in participant information record 30 of every participant in database 32. Step 122 determines if the read parameters match any of the stored biometric parameters in database 32. If the scanned fingerprint parameters match the stored fingerprint parameters in any existing participant information record 30, the participant may be denied the ability to donate plasma and further investigation may be warranted. If the scanned fingerprint parameters do not match any of the stored fingerprint parameters in database 32, step 124 creates a new participant information record and the scanned fingerprint parameters are assigned and stored in the new participant information record. The new participant information record is completed by obtaining one or more items of personal information of the participant and the system advances to step 140 as described below.

If the participant information record 30 for the participant is found using their personal information, in step 126 the user retrieves participant information record 30. In this embodiment, participant information record 30 contains personal information, at least one biometric identifying characteristic, and the participant's participation history. Personal information includes at least the participant's full legal name and social security number. In this embodiment, the biometric identifying characteristic is the unique biometric parameters obtained from a digital scan of one or more of participant's fingerprints.

In step 128, a scan of one or more fingerprints is taken from the prospective participant on site and in step 130, the unique biometric parameters of those fingerprints are compared to the participant's fingerprint's unique biometric parameters stored in their participant information record 30 obtained at the time participant information record 30 was created. In step 132, participant tracking system 10′ determines if the obtained biometric parameters match the known biometric parameters in participant information record 30. If the unique biometric parameters do not match the unique biometric parameters stored in participant information record 30, the participant is tagged with a status of “failure” and the user may further investigate the situation and the user may not allow the prospective participant to obtain the goods or services. If the scanned unique biometric parameters of the scanned fingerprint match the unique biometric parameters in participant information record 30, participant tracking system 10′ thereby validates the identity of the participant. Next, in step 134, participant tracking system 10′ invention compares the participant's participation history to the United States federal regulatory requirements governing the donation of plasma. For example, one participant may not donate more than twice in seven days and one participant may not donate more frequently than once in any two day period. One embodiment includes a virtual machine 44 in the virtual environment 56 performing this comparison and another embodiment includes the clinician reviewing the participation history to determine the participant's status. In step 136, participant tracking system 10′ determines if the participation history allows the participant to obtain the regulated goods and services. If the participant's history is such that the participant is not able to donate plasma at that time (either participant is permanently barred, on hold, has already donated plasma twice in a seven day period or is trying to donate more than once in any two day period) then the participant's status is tagged with a status tag of “failure” for this inquiry. The prospective participant is turned away and the participant's participation history is updated to include the failed attempt, the date and time of day of their attempt, and their updated personal information record 30 is stored in database 32 on data storage device 22.

If the participant's history is such that he/she is able to donate plasma at that time, then participant tracking system 10′ performs step 138 and the participant's status for this inquiry is tagged with a status tag of “success” for this inquiry and then in step 140, the participant donates plasma. After the participant donates plasma, in step 142, the date and time of the donation is logged and the participant's participation history is updated to reflect the current plasma donation including the status tag. Finally, in step 144, the updated participation history is stored in participant information record 30 that is then updated in database 32 and stored on back-end server 42. The updated participation record 30 may be referenced the next time the participant comes into any plasma donation center connected to participant tracking system 10′.

A third embodiment of the system of the present invention (not shown in any figures) includes the remote user interface being configured into a kiosk station in a lobby or receiving area of the center that can be accessed and used directly by an individual participant. The remaining elements of the participant tracking system and method of use of the present invention shall be as described above. In this embodiment, the user of the participant tracking system of the present invention may also include the participant himself or herself in addition to the clinician or employee described above. The methods of use of this embodiment are substantially identical to those described above.

The participant tracking system of the present invention as applied to the plasma donation industry may be used by a variety of clinical providers in a number of locations across the country. One embodiment includes every plasma donation center throughout the United States using the participant tracking system of the present invention to track and validate participant donors. All of these clinics may create patient information records in the system of the present invention and can use the system of the present invention to validate all prospective donors and track their activities industry wide to prevent allowing a plasma donation participant from donating outside of the regulated time intervals. This prevents the clinics from being liable to the regulatory agency in the form of fines or, ultimately, the possibility of revocation of its operating license by continually providing services to a participant that is attempting to circumvent the regulations to earn more money.

The participant tracking system of the present invention may be applied to various industries and markets to ensure the provider of goods and servicers have the ability to follow the particular participant industry wide throughout all outlets in the United States and not just within an individual provider's proprietary tracking system.

From the foregoing, it may be seen that the participant tracking system and method of use of the present invention is particularly well suited for the proposed usages thereof. Furthermore, since certain changes may be made in the above invention without departing from the scope hereof, it is intended that all matter contained in the above description or shown in the accompanying drawings be interpreted as illustrative and not in a limiting sense. It is also to be understood that the following claims are to cover certain generic and specific features described herein.

We claim:

1. A system for tracking a plurality of participants obtaining regulated goods or services comprising:
a database including a plurality of participant information records, each participant information record including at least one unique personally identifiable characteristic and a participation history for each said participant;
a plurality of entities providing said regulated goods or services, each of said entities having at least one remote user interface to create, access, and update at least one of said participant information records contained in said database;
at least one centralized processor in electrical communication with said remote user interface through a network;
a digital data storage device in electronic communication with said remote processor wherein said database is stored on said digital data storage device;
at least one security feature to prevent unauthorized access to said database; and
a participant status determined by comparing said participant's individual participation history to a set of current regulations wherein said participant's individual participation history is updated to include said determined participation status and said database is updated to include said updated participation history.

2. The participant tracking system of claim 1 wherein said participant status is tagged a “success” when said participation history satisfies said current regulations and said participant status is tagged a “failure” when said participation history does not satisfy said current regulations.

3. The participant tracking system of claim 1 wherein said participant status is communicated from said processor to said remote user interface through said network.

4. The participant tracking system of claim 1 wherein said participant tracking system is configured to include participant information records for said participants throughout an entire jurisdiction wherein said goods or services are regulated.

5. The participant tracking system of claim 4 wherein said jurisdiction is the United States of America.

6. The participant tracking system of claim 1 wherein said security feature is a username and password in combination with validating a USB key from a biometric characteristic reader of said remote user interface.

7. The participant tracking system of claim 1 wherein said unique personally identifiable characteristic is a biometric characteristic.

8. The participant tracking system of claim 7 wherein said biometric characteristic is at least one fingerprint of said participant.

9. The participant tracking system of claim 1 wherein the participant is a plasma donor and said regulations are the United States federal regulations regarding the frequency and amount of plasma donations said plasma donor may provide in a given time period.

10. A system for tracking a plurality of plasma donors comprising:
a database including a plurality of participant information records, each participant information record including at least one unique biometric characteristic and at least one participation history event for each said participant;
a plurality of plasma donation centers, each plasma donation center having at least one user interface to create, access, and update a potential donor's participant information record contained in said database wherein said user interface includes a biometric characteristic reader;
at least one central processor accessible by said user interface through the internet;
a digital data storage device in electronic communication with said central processor wherein said database is stored on said digital data storage device;
at least one security feature to prevent unauthorized access to said database; and
a participation status determined by comparing said donor's participation history to a set of current regulations wherein said donor is approved for plasma donation when said donor's said participation history does not violate said current regulations wherein said donor's participation history is updated to include a successful plasma donation or a failed donation attempt.

11. A system for tracking a plurality of plasma donors of claim 10 further comprising tagging a participant's status with a status tag in said personal information record, said status tags selected from the group consisting of success, failure, cancelled, hold, and remove.

12. A method for tracking a participant obtaining regulated goods and services comprising:
validating the identity of a participant using at least one unique personally identifiable characteristic;
retrieving a participant information record of said participant, said participant information record including said at least one unique personally identifiable characteristic and a participation history;
comparing said participation history to one or more industry regulation controlling a participant's ability to obtain the regulated goods and services;
allowing said participant to obtain said regulated goods and services when said participation history satisfies said industry regulations; and
updating said participation history to include a date and a time that said participant obtained said regulated goods and services.

13. The method of claim 12 wherein said participant information record is contained in a database, said database is stored on a data storage device.

14. The method of claim 12 wherein a plurality of entities create, access, and update said participant information records contained in said database wherein said entities provide said regulated goods or services.

15. The method of claim 12 wherein said participant is a plasma donor.

16. The method of claim 15 wherein said industry regulations comprise the United States federal regulations regarding the frequency and amount an individual may donate plasma in a given time period.

17. The method of claim 12 further comprising updating said participation history to include the date and time of any failed attempt by a participant to obtain said regulated goods or services.

18. The method of claim 12 further comprising tagging a participant's status with a status tag in said personal information record, said status tag selected from the group consisting of success, failure, cancelled, hold, and remove.

19. The method of claim 12 wherein said unique personally identifiable characteristic is a biometric characteristic.

20. The method of claim 19 wherein said biometric characteristic is at least one fingerprint of said participant.
